(19) United States
(12) Patent Application Publication
(10) Pub. No.: US 2004/0073456 A1
(43) Pub. Date: Apr. 15, 2004

(54) Multiple eligibility medical claims recovery system

(76) Inventors: Joshua L. Gottlieb, Chagrin Falls, OH (US); Simeon Kohl, Coral Springs, FL (US); John DiMaggio, Manalapan, NJ (US); W. Michael McManus, Alpharetta, GA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/456,938

(22) Filed: Jun. 6, 2003

Related U.S. Application Data
(60) Provisional application No. 60/387,018, filed on Jun. 7, 2002.

(51) Int. Cl. G06F 17/60

(52) U.S. Cl. 705/2

(57) ABSTRACT

A multiple eligibility medical claims recovery architecture. A system is provided to perform post-processing of existing claims that were incorrectly filed in accordance existing claims reimbursement rules and regulations. The system is operable to further provide filtering, either locally or remotely, of claims submitted by a health care provider to a payor in a multiple-eligibility regime. Still further, the system is configurable to provide automatic filing of the claims to multiple payors on behalf of the health care provider. A system is provided to interact with other (PBM) systems and technology to provide real-time processing of claims submitted to determine if claims are correctly filed, pass those that are and reject those that are not and provide a means by which such rejected claims can be completed and redirected to the appropriate payer for approval and payment.

### CROSS-REFERENCE TO RELATED APPLICATIONS

The present application claims the benefit of U.S. provisional patent application No. 60/387,018, filed Jun. 7, 2002.

### BACKGROUND OF THE INVENTION

This invention is related to a health care claims processing system, and more particularly, to a claims recovery system for identifying and processing incorrectly filed claims and a claims intercept system for intercepting claims prior to being processed incorrectly.

The existing medical claims system generally operating throughout health care is a system that is being regulated into complexity. Thus, the existing medical claims system is rife with opportunity to defraud the many payor agencies, or simply from existence of the inherent complexities in dealing with such entities, to incorrectly file a claim with the wrong payor. For example, in a dual-eligibility scenario involving both Medicare as a primary payor and Medicaid as a secondary payor, it is common for a medical provider to incorrectly bill Medicaid for a drug, product, or service that should have first been billed to Medicare. Obviously, a standardized, easily accessed and operated system for properly managing filed claims between the two entities would alleviate much of the complexity and confusion. However, this is generally not the case. Multiple eligibility claims systems exist causing claims reimbursement processing to be even more complex and operationally prohibitive to the medical provider than is necessary. A more specific and existing example of such a dual eligibility claim reimbursement problem involves one small area of health care commonly referred to as DME.

Historically, DME (collectively denoted as “Durable and Disposable Medical Equipment and Home Health Care/Home Medical Equipment”) providers supplying equipment that required pharmaceuticals (such as respiratory therapy equipment), also supplied the patient with the related pharmaceuticals. This created two problems. First, the DME provider was (generally) not legally entitled or licensed to supply/dispense pharmaceuticals. Secondly, the DME providers would bill health care payers with a substantial (and more than fair) “mark-up” to the actual cost. Consequently, as a result of the pharmacy industry's complaints and efforts to eliminate such practices, DME providers without pharmacy licenses no longer dispense such drugs. Certain drugs currently covered by the (Medicare) DME Regional Carriers (“DMERCs”) are now being dispensed and billed by pharmacies. Generally, Medicare has not and does not cover “drugs.”

A number of drugs, however, have been approved for Medicare coverage. This minimal coverage by Medicare for drugs began with coverage of those that are needed to make a DME piece of equipment effective. For example, respiratory drugs that are required to make a nebulizer useful, and certain others that are used for specialized treatments or procedures, such as immunosuppressive drugs that are required to prevent an organ transplant from being rejected by the body. This drug classification creates a major problem for pharmacies (the only ones who can legally dispense drugs), since these prescription items have to be billed under Medicare Part B DME Prosthetics, Orthotics, and Supplies (“DMEPOS”) rules, which are substantially different than the rules by which other pharmacy prescriptions are billed to third parties. These rules require both different and additional information than is normally collected by pharmacists and pharmacy practice management systems (the tool by which most pharmacies today are run and managed.) These claims are also submitted using a “batch submission” methodology which is entirely different from the “real-time” submission process used for most pharmacy claims. Also, unlike the real-time process, the batch process does not fit within the pharmacy's normal workflow process.

This has caused a quandary with most pharmacies, whether or not they are currently aware of the wrong and illegal practices they are performing. The pharmacies (dispensing to Medicare patients) have to become Medicare providers or they cannot fill Medicare prescriptions. Some pharmacies are currently Medicare providers while many are not. Many of the pharmacies that have received Medicare provider numbers and are now Medicare Providers have decided that Medicare DMEPOS claims requirements are prohibitively complex and have not, therefore, learned how to or chosen to deal with those requirements. Ignoring these rules, whether by choice or by simply being unaware is, nonetheless, an illegal practice. Failure to know the rules is not a justifiable basis for non-compliance. This challenge is compounded by the fact that most pharmacy practice management systems (i.e., the tool by which pharmacists manage their stores and generally, bill claims) do not handle the claim format for Medicare DMEPOS in their normal workflow nor provide for the knowing pharmacist to collect the information that is required to properly complete a claim for submission to and acceptance for payment by Medicare.

This is where the problems start, and is the driving factor in why this “dual eligible” opportunity for redirecting claims from Medicaid to Medicare (secondary payor to the primary payor), or simply allowing Medicaid the opportunity (and providing the mechanism and tools) to reject claims it has previously allowed and paid. Following is a sample transaction that occurs under these situations. A customer who is eligible for both Medicare and Medicaid coverage enters the pharmacy with a prescription for one of the DME-classified drugs that both Medicare and Medicaid cover. (Note that if a patient has both Medicare and Medicaid, Medicare is always the primary coverage.) However, the pharmacy, not asking about dual coverage, not wanting to know about dual coverage or not knowing how to deal with Medicare, fills the prescription through its pharmacy system as a Medicaid-only prescription. Generally, the Medicaid pharmacy systems operate similar to all other traditional pharmacy workflow processes. The Medicaid PBM (Pharmacy Benefits Manager) System, not knowing that the customer/patient/member is also covered by Medicare, pays for the prescription based on standard Medicaid reimbursement rates.

Because the provider has bypassed Medicare inappropriately, Medicaid has overpaid the provider. Medicaid should have only paid a maximum of 20% of the Medicaid covered amount after Medicare approved and paid the pharmacy provider at its allowable rate. For many Medicare covered drugs, the provider may realize a greater payment from Medicare (since Medicare's allowable rates may be greater), even if the Medicaid agency pays nothing in the form of the 20% co-pay (Medicare only pays 80% of the submitted claim amount capped at a maximum Medicare declared reimbursement rate). In at least one state, Medicaid is auditing pharmacy providers to determine if the state Medicaid Agency has paid for prescription drugs that should have first been billed to Medicare. CMS has the right to fine each provider in excess of $2,000 for each incident. When these inconsistencies are discovered, the auditor demands that the pharmacy refund to Medicaid all payments received for these items. The pharmacy's issues of submitting the claim to Medicare if the pharmacy wants payment, is the pharmacy's issue/problem, not the Medicaid agency. The claims have to be filed to Medicare first, as primary, and then (generally through a Medicare submitted crossover) to Medicaid second, as the secondary (for consideration of payment for the 20% gap, if any, resulting from the Medicare coverage at 80%. As the Medicare and Medicaid (primary and secondary) reimbursement rates differ, the payments often exceed what Medicaid alone would have paid (or, in the case of a rebilled claim, did pay). In many cases, the pharmacy did not collect sufficient information from the patient or doctor to correctly file the claim to Medicare. To file the claim to Medicare, the pharmacy is usually required to go back to the patient and prescribing physician and collect the additional information and then submit the claim and to do so without the assistance of their practice management system that—generally—has no capacity to fill out the complete claim, create the required Medicare supporting documentation, nor to bill Medicare. Without an Explanation of Benefits (EOB) form (or automatic cross-over to Medicaid) from Medicare (for example), the pharmacy cannot file the Medicaid secondary portion. Medicaid costs are materially reduced by discovering these incorrectly filed DME drugs, because Medicaid receives a full refund from the pharmacies and actually will pay a reduced reimbursement when the claim is refiled with Medicaid as the secondary insurance provider.

Currently, there are four drug categories that present a potential problem/opportunity to Medicaid for dual eligible recipients: Immunosuppressive Drugs, which are utilized when the recipient has received an organ transplant; oral Anti-Cancer Drugs, which are utilized in conjunction with, or as an alternative to chemotherapy; Respiratory Drugs, which are utilized in a nebulizer for inhalation therapy; and Infusion Drugs, which are utilized with an infusion pump for the administration of certain pain medications, intravenous antibiotics, and nutrition.

In addition to the drugs, there are two DME supply categories that experience the same sort of misdirected claims submission and payment that have been incorporated into this invention. These are typically processed and submitted to Medicaid by pharmacy providers even though, in the case of dual-eligible patients, they should be submitted to the Medicare system as the primary insurer. These are: Diabetic Supplies, such as test strips, lancets, and glucometers; and Ostomy Supplies, which are typically pouches, but also include other supply items associated with an artificial waste elimination appliance.

What is needed is a system that can identify the suspect wrongly billed and paid claims, a process that allows the pharmacy provider to properly complete the claims for submission to Medicare (true primary payor), tools to reconcile the claims that have been rejected by Medicaid (secondary payor) to enable Medicaid to modify the claims history for bookkeeping purposes and a system that will prospectively filter claims reimbursements of a medical provider that is attempting to improperly bill the secondary payer and redirect the claim back to the provider and provide a system that will enable the provider to complete a claim properly (if improper and/or incomplete) and file electronically the claim to the proper payor entities in the correct order and according to the document format of those entities. What is also needed is a post-processing system that can sort through the voluminous amount of drug and supply data, and process that data to recapture moneys paid for benefits that were incorrectly filed with a payor entity, resulting in an enormous cost savings.

### SUMMARY OF THE INVENTION

The present invention disclosed and claimed herein, in one aspect thereof, comprises multiple eligibility medical claims recovery architecture. A system is provided to perform post-processing analyses and extraction of existing claims that were incorrectly filed in accordance existing claims reimbursement rules and regulations. The system is operable to further provide filtering, either locally or remotely, of claims submitted by a health care provider (“HCP”) to a payor in a multiple-eligibility regime. Still further, the system is configurable to provide automatic filing of the claims to multiple payors on behalf of the health care provider. Lastly, the system is engineered to provide a prospective solution that will create an avoidance of most of these claims ever reaching the PBM claims paying module through a regimented algorithmic screening process.

### BRIEF DESCRIPTION OF THE DRAWINGS

For a more complete understanding of the present invention and the advantages thereof, reference is now made to the following description taken in conjunction with the accompanying drawings, in which:

FIG. 1 illustrates a block diagram of a medical claims recovery system utilizing a third-party solutions provider (SP) to handle claims analysis and identification of improperly paid claims and to enable recovery, in accordance with a disclosed embodiment;

FIG. 2 illustrates a flow chart of the general process for obtaining and filing a claim for the HCP. This systematizes the process of converting the existing claim information to the format required by the primary health care payer on an automated basis, communicate to the HCP what the erroneous or missing data is and to then submit the claim on behalf of the HCP to the primary payer;

FIG. 3 illustrates an alternative embodiment where a claim filed by the HCP is intercepted by the Medicaid PBM, processed to determine if the claim was filed correctly to Medicaid and if so, pass the claim through the rest of the Medicaid PBM in its normal course and, if not, to communicate this to the HCP and provide a means through which the HCP can complete the claim to conform with the rules of the primary payor and, after HCP approves the completed claim to submit the revised, completed claim to the primary payer;

FIG. 4 illustrates an alternative embodiment where a claim filed by the HCP is intercepted remotely (i.e., filtered through) with a remote intercept system (RIS), and processed to determined if the claim was filed correctly with the secondary payor;

FIG. 5 illustrates a flow chart of the claim-handling process for the RIS embodiment of FIG. 4; and

FIG. 6 illustrates a block diagram of an alternative embodiment where the HCP is configured to filter claims locally by a local intercept system (LIS) for routing of the appropriate claims directly to the primary payor (e.g., the Medicare system).

### DETAILED DESCRIPTION OF THE INVENTION

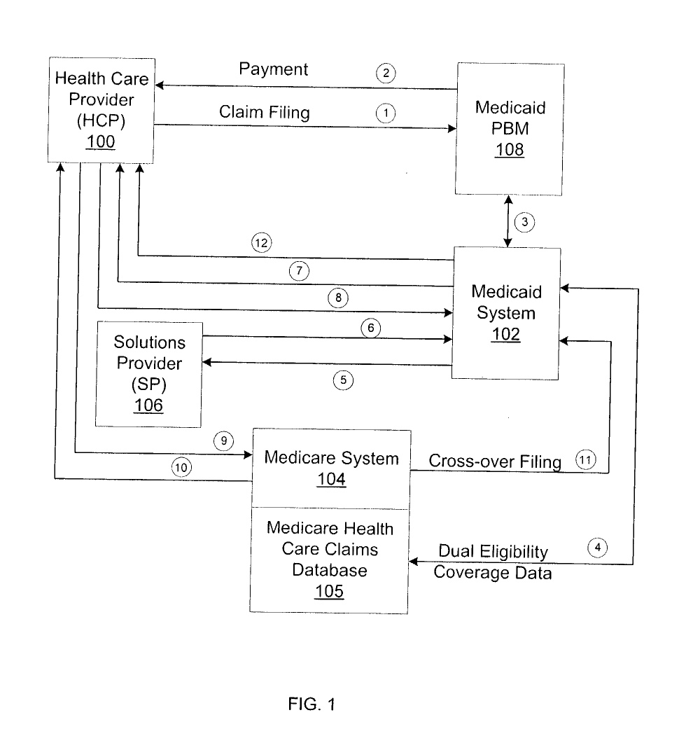

Referring now to FIG. 1, there is illustrated a block diagram of a multiple eligibility medical claims recovery system utilizing a third-party solutions provider (SP) to facilitate claims recovery, in accordance with a disclosed embodiment. A health care provider (HCP) 100 can be a pharmacy, physician, or other similar entity that provides supplies, drugs, and/or medical services to a patient which costs or portions thereof are reimbursable from multiple medical claims payor systems operating under a mandated claims priority payment hierarchy. Continuing the description with two such prominent payors, e.g., a secondary payor 102 (hereinafter using the Medicaid system) and a primary payor 104 (hereinafter using the Medicare system, which contains within it a health care claims database 105), the HCP 100 will eventually seek reimbursement of such associated costs from the payors. Of course, it is to be appreciated that the invention can be used in any dual-eligible or other multiple-eligible reimbursement scheme, including other medical systems such as Blue Cross and any other insurance plans or other schemes.

In addition to the generalized recovery system disclosed herein, the dual-eligibility recovery system has particular application for sorting through the voluminous amount of DME drug and supply data, and processing that data with proprietary rules and algorithms to identify suspect claims in an effort to recapture funds paid for benefits that were incorrectly filed with Medicaid and paid under the erroneous assumption that Medicaid (the secondary payor) was the primary payor. Thus where pharmacies are involved, as described herein, the Medicaid system 102 includes a pharmacy benefits manager 108 (PBM) to interface to the Medicare health care database (that does not include pharmacy data).

In preparation for providing the dual-eligibility recovery feature of the disclosed architecture, other preparatory processes occur. Conventionally, the Medicaid PBM 108 lacks the information necessary to determine which claims, if any, by a particular HCP 100 are also covered by the Medicare system 102, the primary payor. In this particular embodiment, a SP 106 is implemented, in one aspect, to work with the Medicaid system 102 to facilitate the resolution of incorrectly filed claims that were submitted to the Medicaid PBM 108 via a Path (1) and paid by the Medicaid PBM 108 to the HCP 100 via a Path (2) at standard Medicaid reimbursement rates. In furtherance thereof, the SP 106 creates and maintains product set data of dual eligible products, drugs, services, etc., from information received from the Medicaid system 102 and the Medicare system 104, that are covered by both Medicaid and Medicare. The creation of this product set data is described further hereinbelow. Additionally, in this embodiment, the Medicaid system 102 accesses a database of Medicare eligibility information from the Medicare health care claims database 105 via a Path (4) to obtain Medicare eligibility coverage data. The Medicaid system 102 then creates the dual eligibility file, which it passes to the Medicaid PBM 108 via a Path (3), and to the SP 106 via a Path (5). The Medicaid system 102 also receives paid claim information from the Medicaid PBM 108 via the Path (3), and creates a paid claim file from information it receives from the Medicaid PBM 108, which it passes to the SP 106 via the Path (5).

To prepare the Medicaid system 102 for recovery of incorrectly paid claims, the SP 106 uses its proprietary library of algorithms to analyze the dual eligibility file and the paid claim file, which it receives from the Medicaid system 102, to identify and extract incorrectly paid dual eligible claims, which are posted to an electronic file and passed to the Medicaid system 102 via a Path (6). The Medicaid system 102 then issues a notice of recovery to the HCP 100 via a Path (7) to identify the incorrectly paid claims that were filed by the particular HCP 100. The Medicaid system 102 then recovers the amount of the incorrectly paid claims from the particular HCP 100 via a Path (8).

The HCP 100 may then file the claim with the Medicare system 104 via a communication Path (9). Once the Medicare system 104 has completed its processing, the Medicare system 104 issues payment to the HCP 100 via a Path (10), and makes a cross-over filing to the Medicaid system 102 via a Path (11). The Medicaid system 102 then issues payment to the HCP 100 for the proper Medicaid portion of the claim via a Path (12).

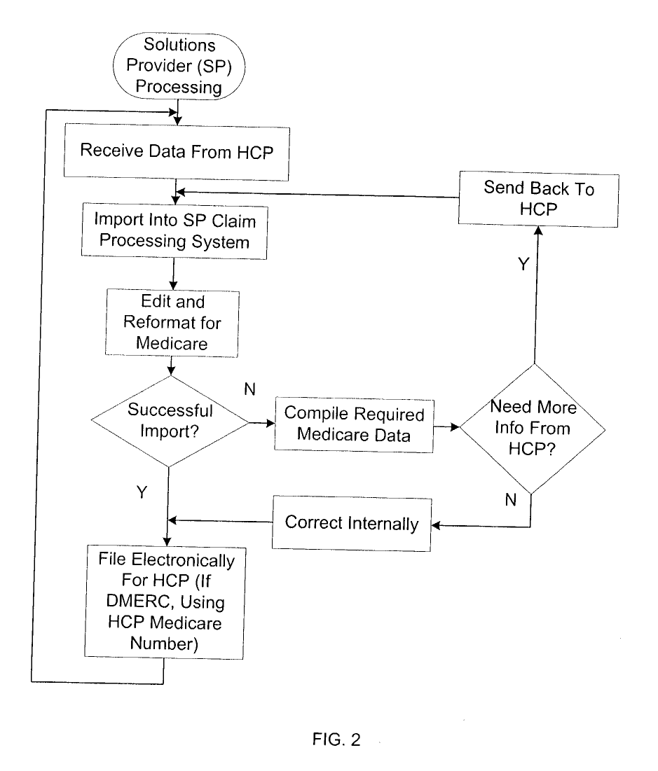

Referring now to FIG. 2, there is illustrated a flow chart of the general process for obtaining and filing a claim for the HCP 100. Once the SP 106 has received a Recovery Notice (RN) from the Medicaid PBM 108 (via the HCP 100), the RN (and existing claim information) is imported into the claim processing system of the SP 106, which reformats the claim into the format required by Medicare. After accessing and compiling the available information from the SP database, if the SP 106 determines that additional information is required from the HCP 100, the SP 106 transmits electronically to the HCP 100 the claim in Medicare format, with the request to complete additional fields required by Medicare. Once all the information is available and the form has been completed and approved by the HCP 100, the SP 106 files the claim electronically to the Medicare system 104 on behalf of the HCP 100. (It should be appreciated that the invention can be implemented over a network, e.g. an Internet, including a suitable interface, e.g. a web browser.) Note that where DME is involved, the SP 106 can be configured with the HCP Medicare number so that filing can be to the DMERC utilizing the HCP Medicare number. Following is a description of the details that need to be accommodated when dealing with DME.

Differences exist in the data requirements for processing claims through a pharmacy system versus processing those claims under Medicare DMEPOS rules. The data elements utilized by the pharmacy system are incomplete from standpoint of Medicare DME requirement, yet still in compliance with Medicaid prescription requirements. Pharmacy claims are on-line real time adjudicated through the pharmacy system using the National Council for Prescription Drug Programs (NCPDP) standard format. The Medicaid claim information processed through the pharmacy system, as prescriptions, only contains the data elements required by a pharmacy system. Medicare DMERC claims are processed as DME orders requiring data elements not available in pharmacy systems. Before converting to Medicare specs, all DME claim elements must be completed.

In reviewing, for example, the data of a state Medicaid system resident on a robust database capable of storing and quickly searching such vast amounts of data, it is clear that insufficient data exists for an offending pharmacy to be in a position to refile the claim with Medicare, as it should have been in the first place.

The data elements which are not contained in a pharmacy prescription may include, but are not limited to the following:

Patient social security number. This is data that should be available within Medicaid data. In certain instances, DMERCs may allow claims to be processed without this data. This data is required in the associated Medicare data field to avoid an empty field being the reason for rejection of a claim.

Patient Medicare Number. This number can be obtained by cross-referencing the Medicaid eligibility file, and in some cases, may also be resident within the Medicaid data.

Doctor Name. Pharmacy systems use the DEA (Drug Enforcement Administration) number as the doctor identification and not the doctor name.

Doctor UPIN (a six-digit alphanumeric Unique Physician Identification Number that is issued to all physicians). Most pharmacy practice management systems do not have a field for the UPIN. In order to find the UPIN for a doctor, the doctor address or portions thereof are required (i.e., at least the zip code). This information may be retrieved from publicly available data systems.

HCPCS (HCFA Common Procedure Coding System). The drugs processed by the pharmacy system all have NDC (National Drug Code) numbers. A cross reference (i.e., “crosswalk”) of NDC numbers to HCPC system numbers is required for the conversion from NDC to HCPCS in order to generate the claims. Additionally, certain dispensation quantity conversions may need to be developed. The System has been imbedded with a developed HCPCS/NDC cross-walk.

Diagnosis Codes (ICD-9: International Classification of Diseases, 9th Revision). Most pharmacy systems do not store the ICD-9 diagnosis code. However, Medicare always requires this for the DMERC claim filing, or the claim will not be paid.

It may be possible to obtain each of these data elements from other sources. For example, the patient social security number and the patient Medicare number could be determined from the Medicaid eligibility files, while the doctor UPIN and other information could be gathered from the Internet.

The HCPCS information is obtained by creating a cross-reference to the NDC numbers, which only left the ICD-9 as the major data element that is unavailable.

The ICD-9 field is critical and must be input to the DMERC claim. While certain ICD-9 codes can be assumed or inferred from the data, there is a risk of error associated with such initiatives. Thus, it is therefore prudent to have the dispensing pharmacy (or an agent whom they engage) do the work to procure the proper ICD-9 code from the treating/prescribing physician.

There are several secondary considerations based upon drug and supply categories that must be resolved before an acceptable Medicare claim can be created from the data that is available.

Immunosuppressive Drugs: The first claim filed requires a DMERC Information Form (DIF) to be electronically attached. The original must be signed by the supplier and filed in the patient's file. It is a requirement if audited by Medicare. The DIF shows which organ was transplanted (this can be determined by the ICD-9), the date of the transplant, the facility where the transplant occurred, whether this organ has been transplanted before, and, if so, did Medicare pay for it. If the claim is filed with the DMERC and the pharmacy does not have the DIF available for review, the pharmacy is subject to penalties.

Oral Aniti-Cancer Drugs: No HCPCS numbers are used, only NDC numbers. The diagnosis defines the type of cancer involved.

Respiratory Drugs: This category has two types of drugs within it: a unit dose form and a concentrate form. A “KO” modifier is attached to the HCPCS number if the drug is unit dose. No modifier is attached if the drug is in a concentrate form.

There are a couple of other problem areas: 1) units, 2) modifiers. The pharmacy would have processed the prescription to Medicaid as units of milliliters (ml); whereas, Medicare requires units of milligrams (mg). Thus it is necessary to convert units on each respiratory drug dispensed.

The modifiers are a different type of problem. The pharmacy system sends items through as individual claims. However, many times two respiratory drugs may be mixed in the unit dose form. If this is done, Medicare requires that a “KP” modifier be attached to the HCPCS of the primary drug and a “KQ” modifier attached to the HCPCS for the second drug. These modifiers determine the final unit pricing for the drug. Each unit dose drug has a higher allowable if it is primary in the mix and a lower allowable if it is secondary in the mix. The data can be processed for all patients who received two of the respiratory drugs on the same day from the same provider, which will indicate if the patient received a unit dose mix. However, because the drugs went to Medicaid singly, it is not readily determinable which is actually the primary. A “best guess” can be utilized based upon the typical configuration, but it will not be 100% accurate. Thus involvement on these issues with pharmacists is beneficial.

Infusion Drugs: These drugs are required to be included on a Certificate of Medical Necessity (CMN) for the infusion pump. These are the least abused of the dualeligible drugs because of the CMN requirement. To create the claims for these, it can be assumed that the CMN was filed by whoever billed the pump to Medicare. With that assumption, there are no further problem requirements.

Diabetic Supplies: These supplies include quantity limits and modifiers. It must be known whether the patient is insulin dependent or non-insulin dependent. This can be determined by the ICD-9. An insulin dependent patient can receive one hundred test strips per month that are covered; whereas a non-insulin dependent patient can receive one hundred test strips every three months that are covered. If quantities are exceeded, the frequency of testing is required on the claim. For insulin dependent patients, a “ZX” modifier is attached to the HCPC; for non-insulin dependent patients a “KS” modifier is attached.

Ostomy Supplies: Different types of pouches have different quantity limitations; however, every pouch type has some quantity limits. If quantity limits are exceeded then extra documentation from the doctor is required on the claim with medical necessity justification about why the excess is needed.

Where the HCP system does not have Internet access and, therefore, cannot access the browser, software (denoted hereinafter as Claim Data Collector (CDC)) is provided (e.g., distribution on a CD) comprising a program along with an accessible database of the claim information from the Medicaid historical data files. This database may contain the information sent by the provider to Medicaid on the original prescription claim, and also has the extra information provided by the SP from the Medicaid files, or from the cross-over files created by the SP, such as the patient social security number, Medicare ID number and, the doctor name and UPIN. The provider will be responsible for reviewing each claim line for each patient to verify and/or correct it. It is possible for some claims to be pushed back to the provider in error; in which case, those will need to be filed by the provider as a “review” with Medicaid. However, it is appreciated that this step can be eliminated.

The key missing item will often be the ICD-9 code, which the provider will need to get from the physician. The physician sometimes only provides a narrative diagnosis; in which case, the HCP would likely utilize a third party (such as the solutions provider or another firm experienced in such coding initiatives.) The HCP's best approach would be to talk to the physician's office to request a fax with certain predetermined information. A form/request can be developed and delivered to the provider with the package of instructions the provider will receive explaining the entire program.

Other missing or problem elements were described above. The provider will have to address each of these; for example, to determine which respiratory drug was primary in order to complete the claim for a mixed unit dose.

However, it is doubtful that the providers will be sufficiently knowledgeable of Medicare rules and regulations to know anything about the quantity limits or the proper modifiers to use with the HCPCs. The solutions provider 106 will be a source to turn to for information on what is needed and how to file the claims. If the provider does not use the SP 106 to file the claims, someone knowledgeable of Medicare rules must be available to help; otherwise, Medicare will reject most of the claims.

The HCP 100 may also utilize the CDC to enter claims for the SP 106 to submit to the Medicare system 104, which claims were previously submitted by the HCP 100 from its pharmacy practice management system to the Medicaid PBM 108, but were rejected by the SP process implemented at the Medicaid PBM 108, because they improperly designated Medicaid as the primary insurer.

With the CDC software and database local to the HCP 100, it becomes a simple process to file claims. The HCP 100 first needs resource material and explanations, for example, a write-up of the problem areas listed above explaining Medicare requirements and what must be done to obtain the information, which can be provided in the software, or the SP 106 can provide access to a help desk where knowledgeable people can answer those questions.

Of course, if the HCP 100 wants the SP 106 to submit the claims, as the provider gathers missing information and is able to complete all required fields in the CDC software, those claims are then transmitted to the SP 106. The software will not send incomplete claims.

Alternatively, if the HCP 100 decides to handle the re-submission of claims that were previously paid by Medicaid as the primary insurer without the assistance of the SP 106, a report can be printed from the CDC software of all claims or only claims with missing information. The HCP 100 can then proceed to correct, supplement, and file the claims directly, reentering the system or submitting completed claims through some other means.

As indicated with respect to the flow chart of FIG. 2, once the SP 106 receives a claims transmission from the HCP 100 (the HCP 100 will have already received the CDC and completed/filled in the missing information), the claims move through the SP system 106, are re-edited and re-formatted for electronic filing with the DMERC (or primary payor's claims processor). Any claim failing the import edits moves to a problem file to be examined by a claims specialist. These claims, where possible are cleaned up internally. Otherwise, the incomplete claims are sent back to the HCP with questions/directions as to what needs to be done to complete the claim. The SP 106 then files the claim using the existing Medicare number of the HCP 100. If the HCP 100 has engaged the SP 106 to become their ongoing billing agent for Medicare, then the SP 106 needs to file the necessary paperwork with Medicare to identify the SP 106 as the billing service of the HCP 100.

Electronic Remittance Notices received back from Medicare are examined by the SP 106. If the claim has been rejected, codes are examined; corrections are made, if possible, and the claim is either re-filed electronically or filed as a “review.” If the claim has been paid, the SP106 compares the paid claim amount against the submitted claim amount to identify and reconcile any discrepancies, which are then transmitted electronically to the HCP 100.

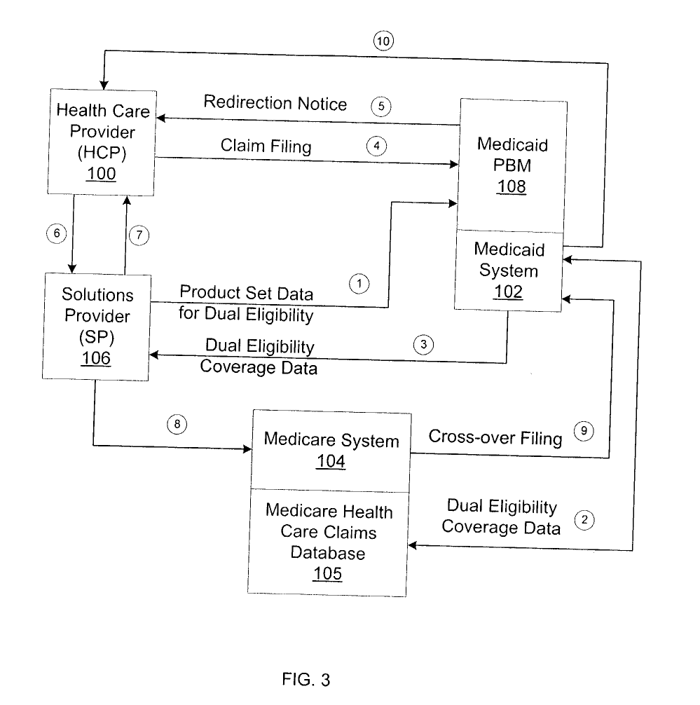

Referring now to FIG. 3, there is illustrated a block diagram of a multiple eligibility medical claims recovery system utilizing the third-party SP 106 to handle claims recovery, in accordance with a disclosed embodiment. In preparation for providing the dual-eligibility recovery feature of the disclosed architecture, other preparatory processes occur. Conventionally, the Medicaid PBM 108 lacks the information necessary to determine which claims, if any, by a particular HCP 100 are also covered by the Medicare system 102, the primary payor. In this particular embodiment, a SP 106 is implemented, in one aspect, to work with the Medicaid system to facilitate the resolution of incorrectly filed claims. In furtherance thereof, the SP 106 creates and maintains product set data of dual eligible products, drugs, services, etc., from the information received from the Medicaid system 102 and the Medicare system 104, that the particular HCP 100 provides, and that are covered by both Medicaid and Medicare. To prepare the Medicaid PBM 108 for redirecting incorrectly filed claims, the SP 106 communicates the dual-eligibility product set information across a Path (1) periodically, or as often as needed, to the Medicaid PBM 108 as the list of products and services provided by the HCP 100 is updated.

Additionally, in this embodiment, the Medicaid system 102 accesses a database of Medicare eligibility information from the Medicare health care claims database 105 via a 10 Path (2) to obtain Medicare eligibility coverage data. The Medicaid system 102 then creates the dual eligibility file, which it passes to the Medicaid PBM 108, and to the SP 106 via Path (3). The SP 106 creates and passes to the Medicaid PBM 108 the dual eligibility product set data (covered by both Medicare and Medicaid, via the Path (1)).

The Medicaid PBM 108 now hosts the Medicare dual eligibility coverage data and the dual eligibility product set data offered by the HCP 100 that the Medicaid PBM 108 uses in accordance with claim processing.

In response to expending the products, drugs, and/or services, when the HCP 100 then files the reimbursement claim (or claims) incorrectly by filing such claim over a communication Path (4) to the secondary payor first, i.e., Medicaid PBM 108, the disclosed architecture operates to provide real-time capture and resolution of the incorrectly filed claim. After receiving the filed claim, the Medicaid PBM 108 compares the claim against the Medicare dual eligible coverage data to determine if the claim should have been filed with the Medicare system 104 first. If so, the Medicaid PBM 108 generates and transmits a redirection notice (RN) back to the HCP 100 over a Path (5) which directs the HCP 100 to route the claim to the SP 106. The HCP 100 then routes the RN to the SP 106 over a Path (6) for resolution.

The SP 106 responds to the HCP 100 over a Path (7) with an eligibility-and-capture notice indicating that the SP 102 has checked the claim information against its product set data (a double-check feature to ensure that both the SP 106 and Medicaid system 102 have the same data), and that additional information is required. The SP 106 is operable to file on behalf of the HCP 100 a Medicare claim in accordance with Medicare rules and regulations. Thus the SP 106 communicates this request for additional information to the HCP 100 over the Path (7). The HCP 100 provides the information to the SP 106, which SP 106 then files the claim with the Medicare system 104 via a communication Path (8).

Once the Medicare system 104 has completed its processing, a cross-over filing can be made by the Medicare system 104 to the Medicaid system 102 via a Path (9). The Medicaid system then issues payment to the HCP 100 for the proper Medicaid portion of the claim via a Path (10). Reporting can be handled in any number of ways, at this point. The Medicaid system 102 can provide notification, the SP 106 will provide notification, the Medicare system 104 can provide notification, or any combination thereof, or even a different entity can provide such service.

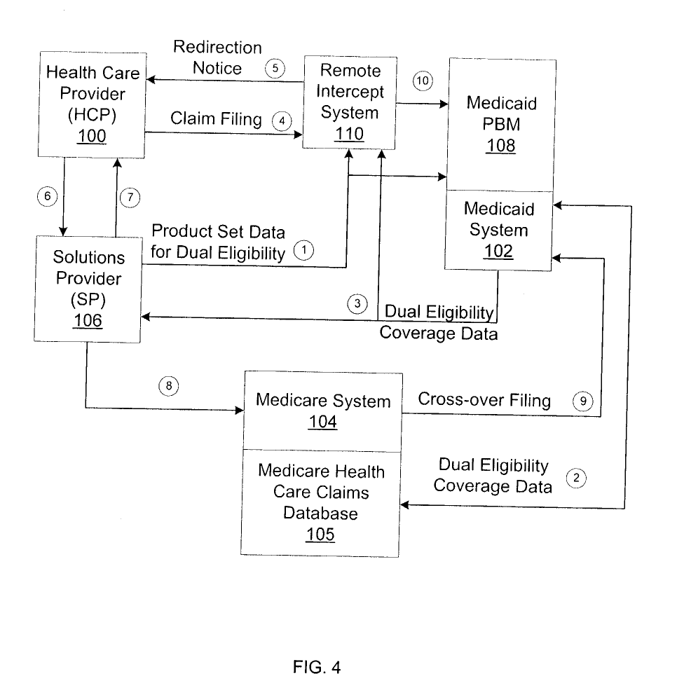

Referring now to FIG. 4, there is illustrated an alternative embodiment where a claim filed by the HCP 100 is intercepted remotely (i.e., filtered through) with a remote intercept system (RIS) 110, and processed to determined if the claim was filed correctly with the Medicaid system 102. The preparatory steps associated with Paths (1), (2) and (3) of FIG. 1 also apply here. However, in this particular embodiment, the dual eligibility coverage database created by the Medicaid system 102 and the dual eligibility product set information created by the SP 106 are also provided to the RIS 110 via the respective paths (3) and (1), such that when the HCP 100 files a claim to the Medicaid PBM 108 over Path (4), the claim is automatically routed to the RIS 110 in real time. The RIS 110 then processes the claim, and issues the RN back to the HCP 100 over Path (5), where the claim is determined to have been filed incorrectly, and the claim is handled according to the remainder of claim processing mentioned in FIG. 1. Note that all claims filed from the HCP 100 are automatically routed to the RIS 110. Thus claims that are filed correctly with the Medicaid PBM 108 are forwarded through the RIS 110 over the Path to the Medicaid PBM 108.

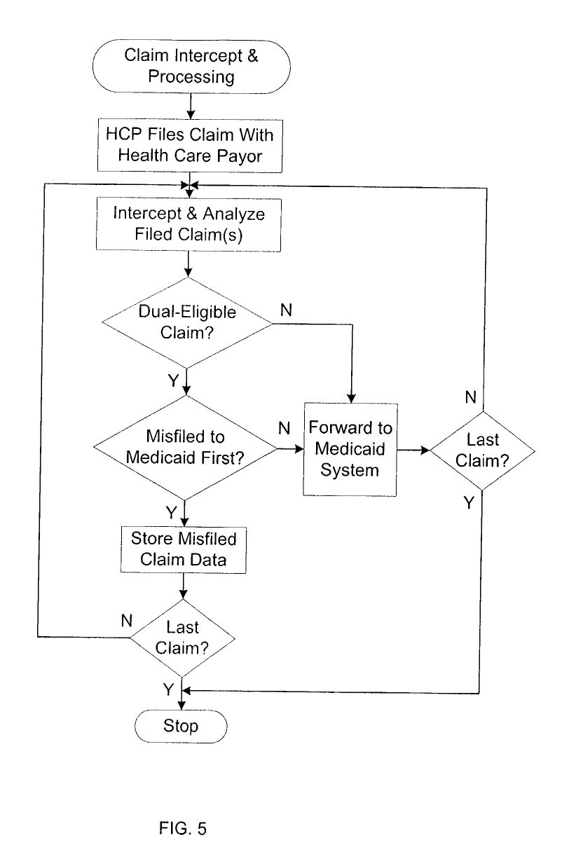

Referring now to FIG. 5, there is illustrated a flow chart of the claim-handling process for the RIS 110 embodiment of FIG. 3. Flow begins where the HCP 100 files a claim a health claim payor, e.g., Medicaid. The RIS 110 then receives the claim, and analyzes the claim information to determine if the claim is one that should be properly forwarded through to the payor, or the claim is an incorrectly filed dual-eligible claim that should be redirected. If not a dual-eligible claim, the claim is forwarded. If a dualeligible claim, yet not filed incorrectly, again, the claim is forwarded to the appropriate payor. However, if both a dual-eligible, and an incorrectly filed claim, the claim data is stored for processing. Flow is then to determine if the last claim has been processed. Note that instead of first processing a batch of claims, and then storing the incorrectly filed claims for later batch processing, each claim can be handled individually, and processed through to completion. Incomplete claims will continue to cycle in and through an HCP's claims until a claim is paid, properly denied or the HCP elects to discontinue efforts to submit a clean claim. Additionally, the architecture is suitable to accommodate intercepting of a third claim while one or more other claims are being analyzed and processed for forwarding and/or redirection.

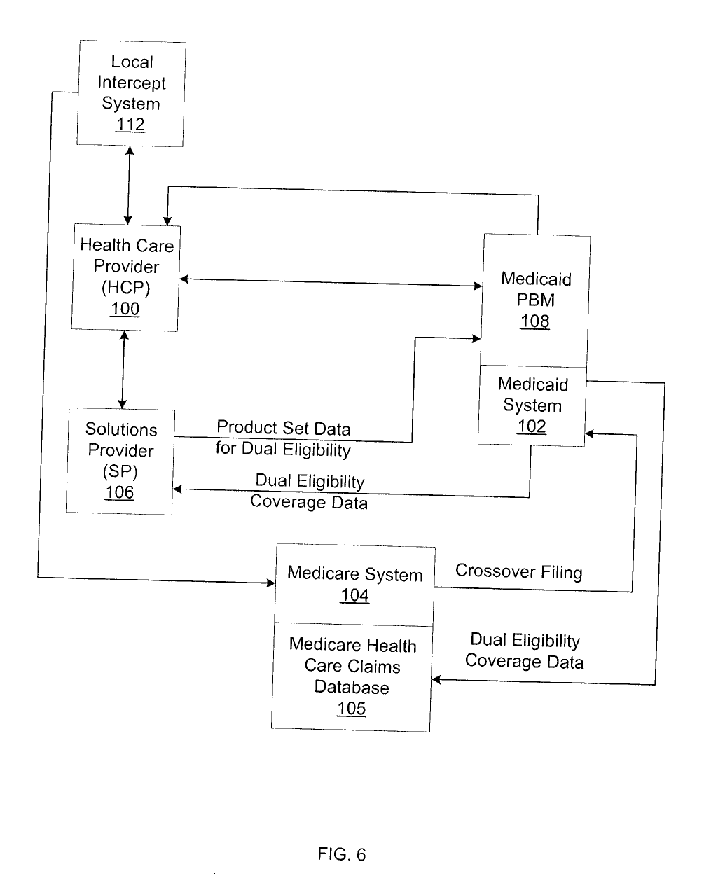

Referring now to FIG. 6, there is illustrated a block diagram of an alternative embodiment where the HCP 100 is configured to filter claims locally for routing of the appropriate claims directly to the primary payor (e.g., the Medicare system 104). The HCP 100 now includes a local intercept system (LIS) 112 which may be simply software through which each claim is processed to ensure that those claims that should be filed first with the primary payor (e.g., Medicare) are not incorrectly filed first with the secondary payor (e.g., Medicaid). The software also would include the information and document processing services that the SP 106 provided in FIG. 3, in addition to the filtering capability provided by the remote intercept system 110.

Continuing with the Medicare/Medicaid example, once a claim is flagged for processing with the Medicare system 104, and requires additional information for processing, the LIS 112 will extract the necessary information from the HCP system 100, or have resident that necessary information to complete processing for filing with the Medicare system 104. The Medicaid system 102 then issues payment to the HCP 100 for the proper Medicaid portion of the claim.

In support of such an implementation, the SP 106 can routinely upload updates to the local intercept system 112 via the HCP system 100, and also download the product set information from the HCP system 100 for use in updating the Medicaid system 102. The product set data and dual eligibility coverage data previously exchanged between the Medicaid system 102 and the SP 106 can still occur where it is desirable to have a system for double-checking claims filed with the Medicaid system 102. However, the dual eligibility coverage data is required by the SP 106 for updating the local intercept system 112.

Although the preferred embodiment has been described in detail, it should be understood that various changes, substitutions, and alterations can be made therein without departing from the spirit and scope of the invention as defined by the appended claims.

We claim:

1. A managing system comprising:
a service provider system for submitting a multiple-eligible reimbursement claim for at least one of goods and services;
a primary payor system for reimbursing claims for a first category of at least one of goods and services;
at least one secondary payor for reimbursing claims for a second category of at least one of goods and services;
wherein the primary payor system comprises a primary implementation for receiving the multiple-eligible reimbursement claim from the service provider system, issuing suitable reimbursement to the service provider system and filing a cross-over claim with at least one secondary provider system; and
wherein the secondary payor system comprises a secondary implementation for receiving the cross-over claim from the primary payor system and issuing suitable reimbursement to the service provider system.

2. The managing system of claim 1 wherein the primary payor system comprises a claims database including a primary payor eligibility information database.

3. The managing system of claim 2 wherein the secondary payor system further comprises:
an implementation for accessing the primary payor eligibility information database to obtain primary payor eligibility information, and combining with secondary payor eligibility information, to create a dual-eligibility file for a particular dual-eligible reimbursement claim; and
a benefits manager system for receiving the dual-eligibility file, for maintaining a paid claim information database, and for returning a paid claim file to the secondary payor system.

4. The managing system of claim 3 further comprising a recovery system for incorrectly-filed and paid claims including:
a solutions system for receiving the dual-eligibility file and the paid claim file from the secondary payor system, creating a file of suspected incorrectly-paid dual eligible claims, and returning to the secondary payor system the file of suspected incorrectly-paid dual eligible claims;
an implementation of the secondary payor system for issuing a notice of recovery to the service provider system in order to recover an incorrectly-paid claim;
an implementation of the service provider for resubmitting the claim with the primary payor system upon recovery by the secondary payor system.

5. The managing system of claim 4 wherein the solutions system includes a claim processing system for determining whether the multiple-eligible reimbursement claim has sufficient information and comprises:
an implementation for notifying the service provider system if additional information is required; and
an implementation for performing internal corrections, formatting the data and filing the claim electronically with the primary payor system if no additional information is required.

6. The managing system of claim 5 wherein the primary payor system is Medicare and the secondary payor system is Medicaid and wherein the solutions system is configured to determine whether the multiple-eligible reimbursement claim includes at least one of: a service provider Medicare number; a patient social security number, a patient Medicare number; a doctor name; a doctor UPIN (Unique Physician Identification Number); an HCPCS (HCFA Common Procedure Coding System); and an ICD-9 diagnosis code.

7. The managing system of claim 4 wherein the solutions system further comprises a claim data collector implementation, residing on a local computer system, comprising:
a software program for accessing a database of historical claim information from the secondary payor system, wherein the database includes data selected from at least one of: information sent by the service provider to the secondary payor for an original claim, extra information provided by the solutions system from the secondary payor's files, information from the files created by the solutions system, a service recipient's social security number, a primary payor ID number, a service provider's name, and an identifying code; and
an implementation for enabling the service provider system to review each data item for verification and correction.

8. The managing system of claim 4 wherein the recovery system further comprises an implementation for providing real-time capture and resolution of an incorrectly-filed multiple-eligible reimbursement claim comprising: an implementation of the benefits manager for comparing a claim against the multiple-eligible coverage data to determine if the claim should have been first filed with the primary payor system;
an implementation for generating and transmitting a redirection notice back to the service provider system, directing the service provider to route an incorrectly-filed claim to the solutions system;
an implementation of the solutions system for sending to the service provider an eligibility-and-capture notice indicating that the solutions system has checked the claim information against its product set data and that additional information is required;
an implementation of the solutions system, upon receipt of additional information from the service provider, for correctly filing the claim with the primary payor system.

9. The managing system of claim 4 further comprising a remote intercept system for determining if the multiple-eligible reimbursement claim is filed correctly with the secondary payor system, the remote intercept system comprising:
an implementation for remotely intercepting a claim filed by a service provider system;
an implementation for comparing the claim with the dual eligibility coverage database and the dual eligibility product set to determine if the claim was filed correctly with the secondary payor system;
an implementation for issuing a redirection notice back to the service provider system if the claim is determined to have been filed incorrectly.

10. The managing system of claim 9 wherein the implementation for comparing determines if the claim should be forwarded through to the secondary payor system, or if the claim is an incorrectly filed dual-eligible claim that should be redirected, and wherein if the claim is a multiple-eligible claim, yet not filed incorrectly, again, the claim is forwarded to the appropriate payor system, and wherein if the claim is both a dual-eligible, and an incorrectly filed claim, the claim data is stored for subsequent processing.

11. The managing system of claim 4 wherein the service provider system further comprises:
a local intercept system for determining if the multiple-eligible reimbursement claim is filed correctly with the secondary payor system, the local intercept system comprising:
an implementation for determining whether a claim is incorrectly filed with the secondary payor system and forwarding to the primary payor system;
an implementation for extracting additional information from the service provider system to complete processing for filing with the primary payor system.

12. The managing system of claim 11 wherein the local intercept system further comprises an implementation for remotely receiving updated database information from the solutions system.

13. The managing system of claim 1 wherein the service provider system is for a health care provider selected from a group including a pharmacy, a physician, and a similar entity and wherein at least one of first and second categories of goods and services is selected from a group comprising at least one of medical supplies, drugs, and medical services to a patient, and wherein the primary and secondary payor systems represent medical insurance entities.

14. The managing system of claim 13 wherein the primary payor system represents Medicare and the secondary payor system represents Medicaid.

15. A method comprising:
submitting a multiple-eligible reimbursement claim to a primary payor for at least one of goods and services;
issuing reimbursement from the primary payor for a first category of at least one of goods and services;
filing a cross-over claim from the primary payor to a secondary payor for a second category of at least one of goods and services; and
issuing reimbursement from the secondary payor for the second category of at least one of goods and services.

16. The method of claim 15 further comprising a method of recovery for incorrectly filed claims comprising:
combining primary payor eligibility information with secondary payor eligibility information, to create a dual-eligibility file of dual-eligible reimbursement claims;
comparing the dual-eligibility file with a paid claim file to create a file of incorrectly-paid dual eligible claims;
recovering a reimbursement for an incorrectly-paid dual-eligible claim;
resubmitting the incorrectly-paid dual eligible claim to the primary payor upon recovery of the incorrectly-paid dual eligible claim.

17. The method of claim 16 further comprising a method determining whether the multiple-eligible reimbursement claim has sufficient information, comprising the additional steps of:
notifying if additional information is required; and
performing internal corrections, formatting the data and filing the claim electronically with the primary payor system if no additional information is required.

18. The method of claim 17 wherein the primary payor system is Medicare and the secondary payor system is Medicaid and wherein, in the step of notifying, the additional information includes at least one of: a service provider Medicare number; a patient social security number, a patient Medicare number; a doctor name; a doctor UPIN (Unique Physician Identification Number); an HCPC (HCFA Common Procedure Coding System); and an ICD-9 diagnosis code.

19. The method of claim 16 wherein the method of recovery further comprises:
locally accessing a database of historical claim information from the secondary payor system, wherein the database includes data selected from at least one of: information sent by the service provider to the secondary payor for an original claim, extra information provided by the solutions system from the secondary payor's files, information from the files created by the solutions system, a service recipient's social security number, a primary payor ID number, a service provider's name, and an identifying code; and
reviewing each data item for verification and correction.

20. The method of claim 16 wherein the method of recovery further comprises:
a method for providing real-time capture and resolution of an incorrectly-filed multiple-eligible reimbursement claim comprising the steps of:
comparing a claim against the multiple-eligible coverage data to determine if the claim should have been first filed with the primary payor system;
generating and transmitting a redirection notice to route an incorrectly-filed claim to the solutions system;
sending an eligibility-and-capture notice indicating that the claim information has been checked against product set data and that additional information is required;
correctly filing the claim with the primary payor system upon receipt of additional information.

21. The method of claim 16 further comprising a method of determining if the multiple-eligible reimbursement claim is filed correctly with the secondary payor system, the method comprising:
remotely intercepting a claim;
comparing the claim with the dual eligibility coverage database and the dual eligibility product set to determine if the claim was filed correctly with the secondary payor system;
issuing a redirection notice if the claim is determined to have been filed incorrectly.

22. The method of claim 21 wherein the step of comparing determines whether the claim should be forwarded through to the secondary payor system, or if the claim is an incorrectly filed dual-eligible claim that should be redirected, and wherein if the claim is a multiple-eligible claim, yet not filed incorrectly, again, a step is performed of forwarding the claim to the appropriate payor system, and wherein if the claim is both a dual-eligible, and an incorrectly filed claim, a step is performed of storing the claim data for subsequent processing.

23. The method of claim 16 further comprising the steps of:
locally intercepting the multiple-eligible reimbursement claim; determining if the claim is filed correctly with the secondary payor system; forwarding an incorrectly filed claim to the primary payor system; extracting additional information to complete processing for filing with the primary payor system.

24. The method of claim 15 wherein the step of submitting is performed by a health care provider selected from a group including a pharmacy, a physician, and a similar entity and wherein at least one of first and second categories of goods and services is selected from a group comprising at least one of medical supplies, drugs, and medical services to a patient, and wherein the primary and secondary payors represent medical insurance entities.

25. The method of claim 24 wherein the primary payor represents Medicare and the secondary payor represents Medicaid.
